(19) United States
(12) Patent Application Publication
(10) Pub. No.: US 2008/0116125 A1
(43) Pub. Date: May 22, 2008

(54) FLUID FILTRATION APPARATUS AND METHOD OF USING THE SAME

(75) Inventors: Vincent P. Nero, Bethel, CT (US); Evan E. Koslow, Springfield, VT (US)

Correspondence Address: LAW OFFICE OF DELIO & PETERSON, LLC., 121 WHITNEY AVENUE, 3RD FLLOR, NEW HAVEN, CT, 06510, US

(73) Assignee: KX Technologies LLC, Orange, CT (US)

(21) Appl. No.: 11/941,232

(22) Filed: Nov. 16, 2007

Related U.S. Application Data
(60) Provisional application No. 60/860,236, filed on Nov. 20, 2006.

(51) Int. Cl. B01D 35/14

(52) U.S. Cl. 210/132; 210/323.1; 210/433.1; 210/434; 210/167.02

(57) ABSTRACT

A filtering apparatus having two distinct filter media for filtering circulating fluid in a circulation system. A portion of the fluid entering the filter passes through a first filter media, while a reduced portion of the fluid entering the filter passes through a second filter media. The second filter media accumulates contaminants and suspended particles from the circulating fluid. The filter media is capable of including at least one additive for treating the circulating fluid. Due to the reduced volumetric fluid flow through the second filter media, the additive can be slowly administered to the circulating fluid over a long period of time. The two filter media may be housed in a dual-canister, where the second filter media may be removed and replaced without removing the first filter media.

### BACKGROUND OF THE INVENTION

1. Field of the Invention

The present invention relates generally to a fluid filtration apparatus, and more specifically to an apparatus and method to remove suspended particles while employing a dual filtration flow while circulating fluid through a filter. The preferred embodiment relates particularly to the removal of suspended particles, the reduction of acidity, and the delivery of additives in circulating engine oil within an internal combustion engine, where the fluid filtration apparatus forms a dual filtration flow circulation path within the filter housing that includes a substantially full-flow path filtered through a first filter media and a reduced-flow path filtered through a second filter media.

2. Description of Related Art

When lubricant oil is exposed to a high temperature in an engine cylinder, a portion of the oil, the calcium components, zinc components, or other ingredients contained in the lubricant oil, are degraded and remain as suspended particles, often being referred to as soot or ash. The addition of suspended particles diminishes the effectiveness of the lubricating system and lubricant, and diminishes the operational life of the engine. The optimum functioning of an internal combustion engine is enhanced when combustion acids are neutralized in the lubricant, and ash and soot are removed. If the combustion acids are not neutralized, the resultant acidity can lead to lubricant gel, increase viscosity, engine deposits, and can shorten engine life expectancy. Through normal operation, engine lubrication, often referred to as engine oil, will acquire acidity and accumulate suspended particles that diminish its lubricating properties.

Government agencies have begun to set goals for the reduction of nitrous oxide in combustion engine byproducts. In order to achieve these goals, engines will require frequent tuning and oil changes. Furthermore, engine gas recycle is rapidly becoming a standard. Engine gas recycle requires a portion of the gases going through the combustion engine to be returned for additional combustion to reduce exhaust emissions. Engine gas recycle, however, also returns a considerable amount of soot back into the combustion process, yielding a far greater accumulation of soot than is presently experienced. Future combustion engine lubricating systems will predictably have more production gases, more weak acids, more soot, and less strong acids. New environmental regulations on emissions, especially for diesel engines, are requiring the removal of soot and ash from the lubricating oil and the addition of engine oil additives for further treatment of the circulating lubricant. Ultimately, low ash oil is desired. Thus, it is desirable to introduce a filter within a circulating lubrication system that has a high affinity for removing suspended particles, such as soot and ash, while maintaining or reducing lubricating fluid acidity.

Without delivering additives to the circulating engine oil, there is not enough alkalinity in the oil composition to survive the numerous oil change intervals that would be required to remove all of the accumulated soot and ash. Especially the soot and ash accumulated in engine gas recycle systems. Generally, the amount of oil in a diesel engine crankcase is on the order of 10 gallons. The alkalinity within the lubricating fluid is predominantly attached and transported with other suspended particles that are trapped and accumulated by the filter media. In this manner, a soap-stabilized calcium hydroxide is typically formed, which basically represents alkaline particles with soot particles attached thereto. Consequently, when the suspended particles are removed, a portion of the needed alkaline particles is removed with them, making the engine oil more susceptible to soot, ash, and acidity.

In U.S. Pat. No. 5,068,044 issued, to Brownawell et al. on Nov. 26, 1991, entitled, “METHOD FOR REDUCING PISTON DEPOSITS,” piston deposits resulting from neutralizing combustion acids circulating within the lubricating system of an internal combustion engine are reduced or eliminated. This is accomplished by first contacting the acids with a soluble weak base in the piston ring zone of the engine. Thereafter, the neutral salts are contacted with a heterogeneous or colloidal strong base mixture immobilized within the lubrication system but outside of the piston ring zone. Although, Brownawell teaches the addition of a weak base and a strong base, there are no provisions for removing suspended particles through a dual filtration flow circulation path within the filter housing, nor are there any provisions for simultaneously delivering the engine oil additives through the same dual filtration flow filtering apparatus.

Independent of engine oil acidity control, the removal of significantly more soot and ash, if performed in current state-of-the-art filters, would still necessitate numerous filter and oil changes. This is due to the volume amount of soot and ash that accumulates within the filter over time. Ultimately, the marketplace is striving for 100,000 miles between oil filter changes, especially in diesel engine operations, where the accumulation of soot and ash within the filter housing becomes the governing impediment to the filter's operational life. With constant particulate collection over the course of 100,000 miles there is not enough space in a typically sized filter housing to store all the accumulated soot and ash, which could be as much as six to eight pounds. This accumulation will dictate the size of the filter canister and the maintenance interval for oil and filter changes. Consequently, different filter constructions are needed to accommodate the goal of 100,000 miles between filter and oil changes.

In U.S. Pat. No. 6,698,097 issued to Gerbert, et al., on Dec. 16, 1997, entitled, “OIL FILTER INCLUDING REPLACEABLE PRIMARY AND SECONDARY FLOW FILTER ELEMENTS,” a filter housing having two flow-filter elements is taught, wherein the housing creates a partial flow of the fluid being filtered through a secondary filter element. Unlike the present invention, the filter media in the Gerbert design does not cause or initiate the partial fluid flow to the secondary filter element. In fact, Gerbert teaches that the secondary filter element is stuffed cotton, which may be more porous than the primary filter element made of strengthened paper. Moreover, the secondary flow-filter element is not fabricated to eliminate soot or ash, or made to impart additives or eliminate acidity in the lubricating fluid. Furthermore, each flow-filter element has its own discharge duct, requiring more complexity to the fluid flow design. Additionally, in the Gerbert design, it is the housing itself that generates the two flow paths, not the filter media.

The present invention provides for an in-line filtering apparatus and method to alleviate suspended particle build-up within a filter, and a mechanism to deliver additives to the fluid without taking the filtering apparatus off-line or out of fluid communication with the circulating fluid.

### SUMMARY OF THE INVENTION

Bearing in mind the problems and deficiencies of the prior art, it is therefore an object of the present invention to provide a fluid filtration apparatus and method for removing suspended particles from circulating fluid where the fluid filtration apparatus forms a dual filtration flow circulation path within a filter housing that includes a substantially full-flow path filtered through a first filter media and a reduced-flow path filtered through a second filter media.

It is another object of the present invention to provide an apparatus and method for delivering and replacing additives in a fluid circulating through a filter medium without losing circulating fluid or changing the primary filter media.

A further object of the invention is to provide an apparatus and method for removing accumulated particles from an in-line dual-filter canister without changing the circulating fluid or the primary filter media.

Still other objects and advantages of the invention will in part be obvious and will in part be apparent from the specification.

The above and other objects, which will be apparent to those skilled in the art, are achieved in the present invention, which in a first aspect, is directed to a filter for removing contaminants from circulating fluid, the filter comprising: a filter canister having an inlet and an outlet; a first filter media; and a second filter media; wherein the first filter media is adjacent the inlet, the first and second filter media within fluid communication with the circulating fluid and forming a dual-flow circulation path within the canister, including a substantially full-flow path filtered through the first filter media and a reduced-flow path filtered through the second filter media.

In a second aspect, the present invention is directed to a filter for removing suspended particles from circulating engine oil in an engine, the filter comprising: a filter canister having first and second filter media, the filter media forming a dual flow oil circulation path within the canister including a substantially full-flow path filtered by the first filter media, and a reduced-flow path filtered by the second filter media; the first filter media including a first porous filter material to provide ingress and egress of substantially all of the circulating engine oil; and the second filter media including a second porous filter material less porous than the first porous filter material such that the circulating engine oil volumetric flow to the first filter media is greater than the oil volumetric flow to the second filter media.

In a third aspect, the present invention is directed to a filter for removing contaminants from circulating fluid, the filter comprising: a canister housing in flow communication with the circulating fluid, having an inlet, an outlet, a first portion, and a detachable second portion, the first and second portions securably attached to seal the circulating fluid therein; a first filter media housed in the first portion adjacent the inlet; and a second filter media housed in the second portion; wherein the first and second filter media are in fluid communication with the circulating fluid and form a dual-flow circulation path within the canister, including a substantially full-flow path filtered by the first filter media and a reduced-flow path filtered by the second filter media.

In a fourth aspect, the present invention is directed to a filter for removing contaminants from circulating engine oil in an engine, the filter comprising: a canister housing in flow communication with the circulating engine oil, having an inlet, an outlet, a first portion attached to the engine, and a detachable second portion, the first and second portions securably attached to seal the circulating engine oil therein; a first filter media housed in the first portion adjacent the inlet; and a second filter media housed in the second portion; wherein the first and second filter media are in fluid communication with the circulating engine oil and form a dual-flow circulation path within the canister, including a substantially full-flow path filtered by the first filter media and a reduced-flow path filtered by the second filter media.

In a fifth aspect, the present invention is directed to a method for accumulating and removing suspended particles in an engine oil filter, the method comprising: flowing circulating engine oil into the filter having a high volumetric flow portion and a restricted volumetric flow portion, the filter attached to an internal combustion engine and in fluid communication with the circulating engine oil, wherein the circulating engine oil flows into and out of the high volumetric flow portion of filter; forming the restricted volumetric flow portion within the filter, the restricted volumetric flow portion in fluid communication with the high volumetric flow portion of the filter, such that a reduced amount of volumetric flow of the circulating engine oil within the filter flows through the restricted volumetric flow portion; accumulating the suspended particles when the circulating engine oil traverses through the restricted volumetric flow portion; removing the suspended particles by removing the restricted volumetric flow portion of the filter.

In a sixth aspect, the present invention is directed to a filter for removing contaminants from circulating fluid, the filter comprising: a filter canister having an inlet and an outlet; a first filter media; and a second filter media; wherein the first filter media is adjacent the inlet, the first and second filter media within fluid communication with the circulating fluid and forming a dual-flow circulation path within the canister, including a full-flow path filtered through the first filter media and a reduced-flow path filtered through the second filter media.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a system having an in-line filtering apparatus with indications for the direction of the circulating fluid flow.

FIG. 2 depicts a filter of the present invention with two filter media housed in a canister with a single inlet and a single outlet.

FIG. 3 depicts the dual canister configuration for a dual-flow path filter in circulating fluid applications.

### DESCRIPTION OF THE PREFERRED EMBODIMENT(S)

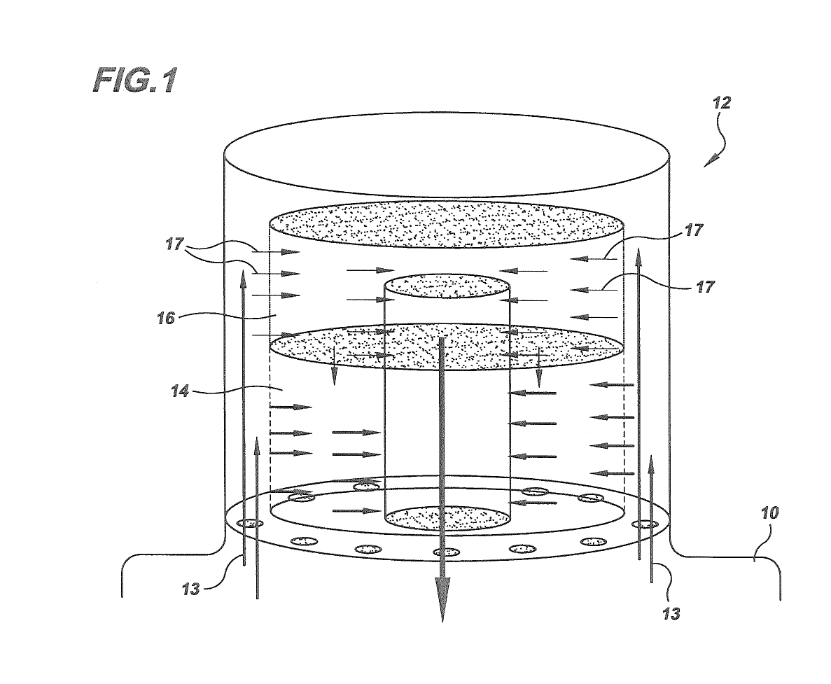

In describing the preferred embodiment of the present invention, reference will be made herein to FIGS. 1-3 of the drawings in which like numerals refer to like features of the invention.

Many applications require circulating fluid flow within a defined area. In such instances, it is usually necessary to remove contaminants from the circulating fluid in order to ensure continued operation and extend the life expectancy of the system in operation. One common example is lubricating oil within an internal combustion engine. Although this is a common application of the present invention, the invention is applicable to other systems as well that require the filtering of circulating fluid. The present invention is described with respect an internal combustion engine as the application for one embodiment; however, other systems are applicable and the present invention is not limited or restricted to any particular system having circulating fluid, such as cooling systems (air conditioners) and hydraulic fluid systems, to name a few. Furthermore, the present invention may also be used to impart additives to circulating fluid, and remove specific particulates.

In a combustion engine operation, lubricating oil is circulated through an engine and carries contaminants and suspended particles such as metal particles, carbon particles, and dirt, which if allowed to remain in the lubricating oil may cause harm to the engine and shorten its effective operating life. In order to effectively lubricate the engine, the engine oil is circulated throughout the engine and in contact with moving components. The oil is flowed through a filter under pressure in order to remove contaminants and suspended particles prior to recirculation. As the engine oil circulates in an internal combustion engine it becomes more acidic over time and gathers more suspended particles. Ultimately, the engine oil becomes too acidic and looses its lubrication properties, and the filter becomes saturated with accumulated particles and must be replaced.

FIG. 1 depicts an in-line filtering apparatus 12 of the present invention connected to a system 10 with arrows indicating the direction of the circulating fluid flow. As the fluid circulates the system, it acquires contaminants that, if not removed, will compromise the system's operational integrity. By flowing the circulating fluid through a filter, it is possible to accumulate contaminants of a predetermined size and keep them from flowing downstream within the fluid. The filtering apparatus 12 is presented with two distinct filter media 14, 16. The circulating fluid 13 in the system is directed to the filtering apparatus 12 under pressure. Substantially all of the fluid entering the filtering apparatus 12 is passed through the first filter media 14. A portion of the fluid 17 that enters the filter is passed through the second filter media 16. As an exemplary embodiment, the filtering apparatus 12 is shown in a cylindrical housing; however, other housing shapes may be employed without compromising the operational integrity of the filter. The present invention is not limited to any particular housing design or shape. Importantly, the housing must be sealably attached to the system to prevent fluid leakage, and easily removable for filter and fluid replacement. The present invention may be combined with a close-valve to prohibit fluid escape during replacement.

Oil filters for gasoline and diesel engines have traditionally been of the “full flow” type in which engine-generated oil pressure is used to flow forceably and directionally all of the oil discharged from the engine through a single filter media in the filter apparatus before returning the oil to the engine. However, smaller contaminants on the order of 10-50 micrometers in the form of suspended particles within the circulating engine oil simply pass through typical filter media and return to the engine. These suspended particles include soot and ash deposits. If a filter media is introduced that is capable of removing suspended particles of this size, it would necessarily be denser and less porous than filter media currently in use, since it must collect much smaller particles. The dense filter would restrict and disrupt the flow of the circulating fluid, and require more frequent changes due to the accumulation of ash and soot. The volume of fluid per unit time through such a dense filter would be significantly reduced, thus making a direct in-line application impractical.

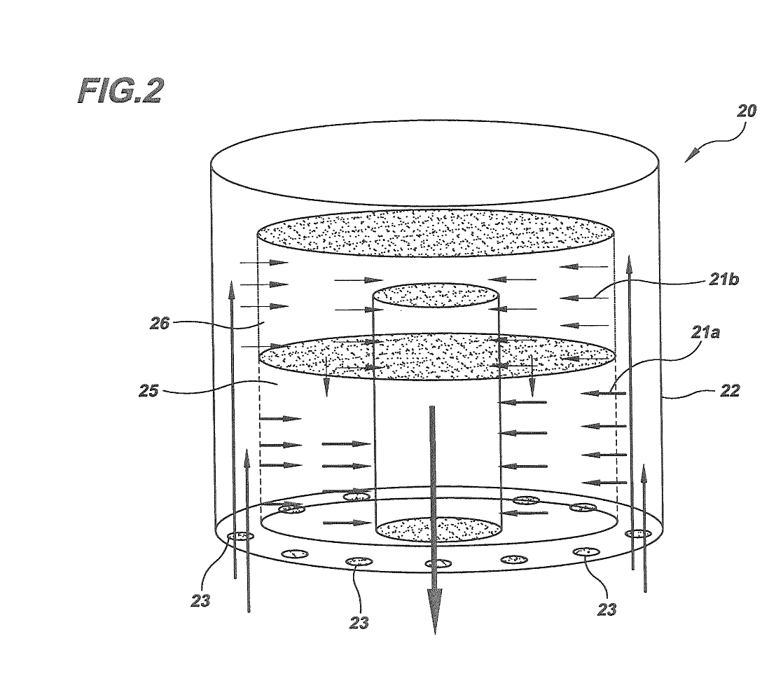

By introducing an in-line filter having two filter media for removing contaminants from circulating engine oil, including suspended particles, the present invention addresses the accumulation over an extended period of time of extremely small, suspended particles without restricting the system's engine oil circulation flow. Referring to FIG. 2, an oil filter 20 with two filter media is housed in a canister or housing 22 with an inlet 23 and an outlet 24. The direction of engine oil flow within the filter is represented by arrows 21a, 21b. Arrow 21a depicts the engine oil flow to the first filter media 25, and arrow 21b depicts the engine oil flow to the second filter media 26. In this embodiment, the initial engine oil flow enters the filter by traversing the sidewalls of canister 22, and returns approximately through the center. It should be noted that the direction of engine oil flow within canister 22 is important to the extent that at least a portion of the engine oil is allowed to traverse second filter media 26 at a reduced flow rate than the fluid entering first filter media 25. The first filter media 25 is adjacent to and in fluid communication with the inlet 23, and the second filter media 26 is situated to receive a portion of the engine oil flow from the first filter media 25. Although only a portion of the engine oil flows through second filter media 26 at any one time, second filter media 26 remains in fluid communication with the circulating engine oil and forms a dual-flow circulation path within canister 22 with first filter media 25.

First filter media 25 allows the circulating engine oil to traverse through the filter at a rate sufficient to maintain proper system operation, while second filter media 26 within the same filter housing is capable of simultaneously removing extremely small, suspended particles from a portion of the engine oil within canister 22. According to FIG. 2, filter 20 of the present invention has canister 22 mounted to a system, such as a piston engine, in-line and in fluid communication with circulating engine oil traversing through the system. First filter media 25 is considered the primary filter, and allows for normal fluid flow of the circulating engine oil. The first filter media 25 may be coarse particles, or fibrous materials, such as paper, and the like. In a preferred embodiment, the filter is designed so that the first filter media 25 receives a substantial portion of the circulating engine oil flowing to the filter canister 22 from single inlet port 23. The reduced flow of the circulating engine oil in the second filter media 26 is caused by a pressure differential in the fluid flow between first filter media 25 and second filter media 26. The pressure differential results from differences in material flow properties of the first filter media and the second filter media, predominantly caused by the density difference between the two filter media. For example, if the first filter media is composed of a paper filter, the second filter media may be a denser and less porous paper filter relative to the first filter media's porosity. As fluid traverses through the filter under pressure, the first filter media will allow more fluid to flow therethrough, while the second filter media will restrict the fluid flow. Thus, the first filter media is capable of allowing for a greater volumetric fluid flow through the filter due to its greater porosity in comparison to the porosity of the second filter media. The first and second filter media may also be composed of the same filter material, where the second filter media is packed tighter than the first filter media such that the volumetric flow of the circulating fluid is reduced as the fluid flows from the first filter media to the second filter media. Generally, the pressure differential is a result of the fluid flow through the two media. By having the second filter media perform at a lower volumetric flow rate, any increase pressure caused by the fluid flowing through the second filter media will be insubstantial. Thus, soot and other small, suspended particles may be accumulated but not substantially compacted into a cake-like substance, as they would otherwise be compacted if subjected to the flow-induced pressure experienced within the first filter media.

In one embodiment, the first filter media includes coarse particles and the second filter media includes fine particles relative in size to the coarse particles of the first filter media. The fine particles represent the denser filtration media, which helps attribute to the differential pressure between the two filter media under fluid flow conditions, and restricts the flow of the circulating fluid such that the second filter media receives a reduced portion of the circulating fluid entering the first filter media. Examples of coarse and fine particles for the filter media include, but are not limited to, micron-sized particles or nano-sized particles, which are on the order of 10 nm to 1 micron. By receiving a reduced portion of the circulating fluid, the second filter media receives the smaller portion of fluid in a second fluid flow loop or path. The first and second filter media may comprise high content cellulose and a strengthener, where the strengthener includes polyester, phenolic resin, or cotton, with the second filter media more tightly packed. The second filter media may also be composed of microporous nanofibers, where the nanofibers include cellulose fibers adapted to hold a base material without a binder. Alternatively, the nanofibers can be formed as a microporous media. As used herein, the term nanofiber means a fiber, whether extending from a core fiber or separated from a core fiber, having a diameter less than about 1000 nanometers. Nanofiber mixtures typically have diameters of about 50 nanometers up to less than about 1000 nm and lengths of about 0.1-6 millimeters. Nanofibers preferably have diameters of about 50-500 nanometers and lengths of about 0.1 to 6 millimeters.

As long as the second filter media includes filter paper that is less porous relative to the first filter media, the fluid flowing through the filter will sustain a pressure differential due to the flow differential through the two media. By its density and porosity, the second filter media is made to restrict the volumetric flow of the circulating fluid. Preferably, the volumetric flow to the second filter media is substantially less than the volumetric flow to the first filter media so that accumulation of suspended particles in the second filter media is gradually achieved over time. The reduction in volumetric flow through the second filter media is preferably greater than ninety percent (90%) of the total volumetric flow. Preferably, the volumetric flow through the second filter is less than 5%, which is a 95% reduction compared to the volumetric flow through the first filter media. More preferably, the circulating fluid to the second filter media is restricted by properties of the second filter media such that the volumetric flow to the second filter media is at least less than three percent of the volumetric flow to the first filter media. Optimally, the volumetric flow through the second filter media is less than one percent of the volumetric flow through the first filter media.

Generally, it is advantageous to have the capability of administering additives to circulating fluid from a filter in contact with the circulating fluid. When the fluid filtering apparatus is replaced during periodic maintenance cycles, the additives may then be replenished. In the present invention, the either filter media is capable of including at least one additive for treating the circulating fluid. Preferably, the additive is combined in the second filter media. In this manner, the additive is slowly administered to the circulating fluid over a longer period of time, since the volumetric flow of fluid to the second filter media is significantly less than that of the first filter media. A two-stage, time-sensitive administration of additives may also be employed. The first filter media, which is subjected to larger volumetric fluid flow, is capable of releasing additives to the circulating fluid much more quickly than the second filter media. The second filter media is exposed to considerably less fluid flow over the same time period, and will release additives to the circulating fluid at a significantly slower rate. Alternatively, the second stage of the present invention may be simply an additive replacement media, without significant filtering properties. In this manner, due to the limited volumetric flow of the circulating fluid to the second stage, the additives introduced to the fluid will release at the desired slower rate.

In an internal combustion engine, the circulating engine oil becomes more acidic as the engine operates. Making the oil more basic, thus reducing the engine oil acidity, helps prolong usage and the life of the engine. An additive may be administered by either the first or second filter media, or both, that includes a strong base and a soluble weak base for the exemplary embodiment of an internal combustion engine. The weak bases are generally basic metallic salts of weak organic acids, basic organonitrogen compounds, or mixtures thereof. Examples of organonitrogen compounds include, but are not limited to, pyridines; anilines; alkyl, dialkyl, and trialky amines; alkyl polyamines; and alkyl and aryl guanidines. When amines or other weak bases are added to the second filter media, the organic media replenishes the oil with base, thus raising the total base number (TBN). It is preferred that at least one additive includes amines as an organic media to administer base to the circulating engine oil. The weak base must be strong enough to act to neutralize the combustion acids, usually by forming a salt or neutral compound. Following neutralization, the neutral salts are passed or circulated with the lubricating engine oil and contacted with the strong base added to the filter media. The strong base replaces the weak base from the neutral salts and returns the weak base to the circulating fluid. The preferred strong-base additives include, but are not limited to, magnesium oxide (MgO) and magnesium hydroxide (Mg(OH)₂). Other strong bases include: calcium carbonate (CaCO₃), calcium oxide (CO), sodium hydroxide (NaOH), zinc oxide (ZnO), or other zinc mixtures. The amount of strong base required will depend upon the amount of weak base in the fluid. Both strong and weak bases may be added to the circulating engine oil by a single filter media, simultaneously.

The preferred target total base number (TBN) for the additive is approximately 5. It is also possible for filters of the present invention in engine applications and other circulating fluid applications to administer more than one additive at a time, depending in part upon the binding properties of each additive to the filter media and the number of filter media employed. For engine oil, it is preferred that at least one additive be a dispersant, such as high molecular weight acids or organic amines. Providing additives within the oil itself is not easily accomplished and can make the oil unstable. Thus, providing additives within the filter media, particularly the second filter media where the volumetric fluid flow is significantly much less, allows for the gradual administration of the additives, and subsequent replenishment when the second filter media is replaced.

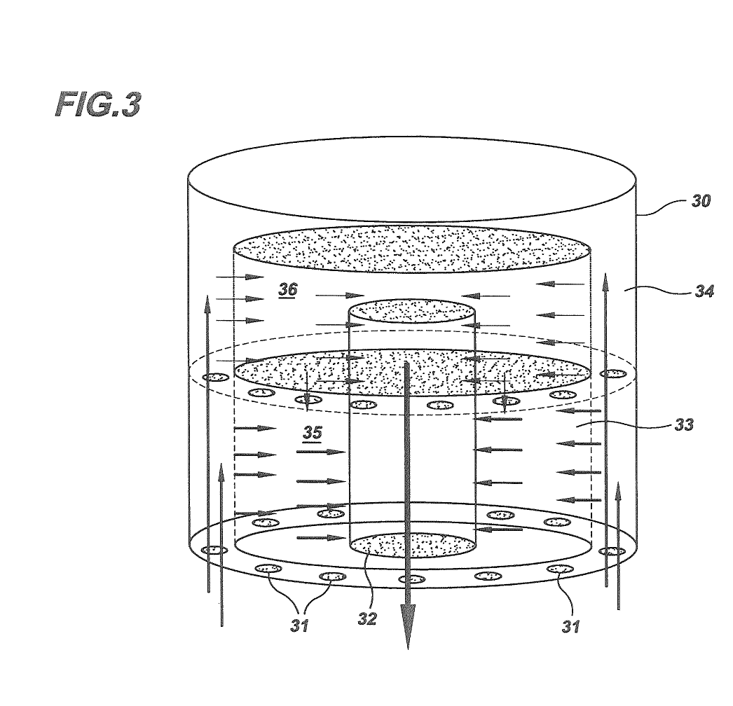

In order to more effectively and efficiently solve the problem of the accumulation of suspended particles acquired by the filter, a dual canister configuration is proposed. FIG. 3 depicts the dual canister configuration for a filter in circulating fluid applications. The dual can filter includes two-portioned housing 30 that is in flow communication with the circulating fluid. The housing has at least one inlet 31, one outlet 32, a first portion 33, and a detachable second portion 34. The first and second portions are securably attached to seal the circulating fluid therein, without leaking. Preferably, first filter media 35 is housed in first portion 33 adjacent the inlet, and second filter media 36 is housed in second portion 34. The first and second filter media remain in fluid communication with the circulating fluid and form a dual-flow circulation path within the two-portioned housing, including a substantially fill-flow path filtered by the first filter 35 media and a reduced-flow path filtered by the second filter media 36. In the course of a scheduled maintenance cycle, or when an adequate amount of soot and ash has accumulated in the second filter media 36, the second portion 34 of the two-portioned housing holding the second filter media 36 is removed, discarded or recycled, and replaced with a new second portion including a new second filter media. In this manner, the accumulated ash and soot is removed, and additives that have been added to the second filter media are replenished to the system for continuing discharged into the circulation fluid. The dual-canister (two-portioned housing) configuration presents the opportunity to administer and replenish multiple additives, which normally deplete over time, such as antioxidants and dispersants.

The advantageous flow differential in the two filter media zones can provide a beneficial additive profile for the filter. The addition of additives to the two filter media zones can provide three zones for filter additive delivery to the lubricating oil passing through the filter. The first filter media can have one or more additive which can have a higher release as the majority of the oil passes through it. The second filter media has substantially less oil passing though it and can have a second and slow additive release rate. The third additive release rate can be based on the release rates of the two media and can include a release of a first additive in the first media for reaction of a second additive being released in the second media. Since the rate of flow through the second media is lower than flow through the first media, a reaction time of suitable length can be provided in the second media. Additives which and be added to one or more of the filter media include: dispersants; ashless dispersants; detergents; metal-based detergents; metal rust inhibitors; antioxidants or oxidation inhibitors, such as, alkaline earth metal salts of alkyl-phenyl esters, diphenylamine and phenyl-napthylamines; extreme pressure additives, such as, sulfurized fats and oils; metal deactivators; anti-wear additives, such as, zinc dialkyldithiophosphates (ZDDP); antifoamants; friction modifiers; seal swell agents; demulsifiers; VI improvers, such as, functionalized olefin copolymers; pour point depressants; lube oil flow improvers; corrosion inhibitors; wear reduction agents; gel slow release additives, such as disclosed in U.S. Pat. No. 6,843,916, incorporated herein by reference thereto; PTFE; MoS2; graphite; carbon nanotubes, such as described in U.S. Pat. No. 6,828,282, incorporated herein by reference thereto; dyes; molybdenum/sulfur moiety nanoparticles, such as described in U.S. Pat. No. 6,878,676, incorporated herein by reference thereto; molybdenum dialkyldithiocarbamates; trinuclear molybdenum compounds; and soot handling lubricant additive packages, such as those disclosed in U.S. Pat. No. 6,844,301, incorporated herein by reference thereto.

Although, all of the aforementioned additives may be employed advantageously in the dual zone filter of the instant invention, several are of particular interest owing to the use of nanofiber paper in the filter media of the dual filter. The nano-sized components in U.S. Pat. Nos. 6,828,282 and 6,878,676 are of particular interest owing to the nano-sized components' ability to interact with the nanofiber paper of the first and second filter media. Further, the implementation of a dual additive release mechanism by use of the gels of U.S. Pat. No. 6,843,914 provide for a dual rate release in a single filter media. In addition, since the instant invention provides an advantageous mechanism for reducing the soot in circulating lubrication oils in engine lubrication systems, the use as an additive of a lubricant additive package with good soot handling capabilities, such as, U.S. Pat. No. 6,844,301, is beneficial.

Furthermore, by modifying the housing to have an easily removable second portion that holds in place the second filter media, it is possible to change the additives and remove the soot and ash without removing the in-line first housing portion that holds in place the first filter media, which if removed would require fluid replacement. This design significantly reduces the amount of fluid loss during ash and soot removal, and during additive replacement. Preferably, fluid flow through the filter first and second portions is separated by one-way valve structures 37 to restrict fluid from draining from the engine when the filter second portion is removed. It is understood that for typical internal combustion engines, the engine must be turned off during filter replacement.

The first and second portions 33, 34, are preferably joined by a junction, which is preferably gasketed and capable of hand tightening for a leak-free seal. Preferably, the first and second portions are threaded for tightening and separation, although other sealable attachment schemes, such as friction-fitted or latch-locked, to name a few, are certainly acceptable in the present design. The second filter media 36 of second portion 34 is distinctly different from the first filter media 35, being less porous or more tightly packed to establish the necessary pressure differential during normal fluid flow. Once again, the volumetric fluid flow through the second filter media is significantly less than the volumetric fluid flow through the first filter media.

The application of the filter of the present invention includes the practice of a method for filtering circulating engine oil in a piston engine, and accumulating and removing suspended particles from the circulating engine oil as part of the engine's continual operation. The method includes a first step of flowing the circulating engine oil into a filter, which has a high volumetric flow portion and a restricted volumetric flow portion. The filter is attached to the piston engine and in fluid communication with the circulating engine oil. The circulating engine oil flows into and out of the high volumetric flow portion of filter through the first filter media. The high volumetric flow portion is adjacent the filter's inlet, and includes a first filter media. A restricted volumetric flow portion is introduced within the filter, comprising a second filter media. The restricted volumetric flow portion remains in fluid communication with the high volumetric flow portion of the filter, such that a reduced amount of volumetric flow of the circulating engine oil within said filter flows through the restricted volumetric flow portion. The filter is configured to accumulate and remove suspended particles in the second filter media when the circulating engine oil traverses through the restricted volumetric flow portion.

Changing the second filter media in the restricted volumetric flow portion involves physically separating the restricted volumetric flow portion from the high volumetric flow portion. Once the second filter portion containing the second filter media is removed, a new second filter portion and second filter media is attached. This replacement may be based on a scheduled maintenance interval, a predetermined length of operating time (or distance), or when a predicted, predetermined level of suspended particles has accumulated. Since the replaceable second filter media can hold additives as well, the method of the present invention provides for the replenishment of multiple additives within the second filter media whenever the second filter portion is replaced.

In the case of circulating engine oil for an internal combustion engine, the present method for adding additives to either the first or second filter media in a replaceable filter housing includes replenishing additives for reducing acidity in the circulating engine oil by providing the necessary chemistry to the appropriate filter media.

Of course, it should be clearly understood that there are a wide variety of other applications other than those specific applications set forth herein which may benefit from incorporation of one or more fluid filters along a fluid flow path. Accordingly, it is contemplated that such applications may include, but are not necessarily limited to, vehicle engine applications including air conditioning coolant systems, automotive coolant systems, and brake systems, to name a few, non-vehicle engine applications, such as fuel delivery systems, air conditioners, hydraulic systems, turbine engine applications, as well as any other applications not specifically recited herein but characterized by a fluid flow within a defined area.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A filter for removing contaminants from circulating fluid, said filter comprising:
a filter canister having an inlet and an outlet;
a first filter media; and
a second filter media;
wherein said first filter media is adjacent said inlet, said first and second filter media within fluid communication with said circulating fluid and forming a dual-flow circulation path within said canister, including a substantially full-flow path filtered through said first filter media and a reduced-flow path filtered through said second filter media.

2. The filter of claim 1 wherein said first filter media receives substantially all of said circulating fluid to said canister from said inlet, and said second filter media receives a reduced portion of said circulating fluid.

3. The filter of claim 1 wherein reduced flow of said circulating fluid in said second filter media is caused by a pressure differential between said first filter media and said second filter media, said pressure differential resulting from differences in material flow properties of said first filter media and said second filter media.

4. The filter of claim 1 wherein said first filter media includes coarse particles and said second filter media includes fine particles relative to said first filter media coarse particles, wherein said fine particles restrict flow of said circulating fluid such that said second filter media receives a reduced portion of said circulating fluid.

5. The filter of claim 1 wherein said first filter media includes a first porous filter paper and said second filter media includes a second porous filter paper relative to said first porous filter paper, wherein said second porous filter paper restricts volumetric flow of said circulating fluid such that said second filter media receives a reduced portion of said circulating fluid.

6. The filter of claim 1 wherein said filter media includes at least one additive for treating said circulating fluid, said at least one additive added to said first filter media, said second filter media, or said first and second filter media.

7. The filter of claim 5 wherein flow of said circulating fluid to said second filter media is restricted by properties of said second porous filter paper such that said volumetric flow to said second filter media is substantially less than said volumetric flow to said first filter media.

8. The filter of claim 5 wherein flow of said circulating fluid to said second filter media is restricted by properties of said second porous filter paper such that said volumetric flow to said second filter media is approximately equal to or less than five percent of said volumetric flow to said first filter media.

9. The filter of claim 5 wherein flow of said circulating fluid to said second filter media is restricted by properties of said second porous filter paper such that said volumetric flow to said second filter media is approximately equal to or less than three percent of said volumetric flow to said first filter media.

10. The filter of claim 1 wherein said first and second filter media comprise the same filter material, and wherein said second filter media is packed tighter than said first filter media such that volumetric flow of said circulating fluid is reduced as said fluid flows to said second filter media.

11. The filter of claim 1 having said first and second filter media comprise high content cellulose and a strengthener.

12. The filter of claim 11 wherein said strengthener includes microporous polyester, phenolic resin, or cotton.

13. The filter of claim 1 wherein said second filter media comprises microporous nanofibers.

14. The filter of claim 13 wherein said microporous nanofibers include cellulose fibers adapted to hold a base material without a binder.

15. The filter of claim 13 wherein said microporous nanofibers include nanofiber carbon.

16. A filter for removing suspended particles from circulating engine oil in a piston engine, said filter comprising:
a filter canister having first and second filter media, said filter media forming a dual flow oil circulation path within said canister including a substantially full-flow path filtered by said first filter media, and a reduced-flow path filtered by said second filter media;
said first filter media including a first porous filter material to provide ingress and egress of substantially all of said circulating engine oil; and
said second filter media including a second porous filter material less porous than said first porous filter material such that said circulating engine oil volumetric flow is reduced through said second filter media.

17. The filter of claim 16 wherein reduced volumetric flow of said circulating engine oil in said second filter media is caused by a pressure differential between said first filter media and said second filter media, said pressure differential resulting from differences in porosity between said first filter media and said second filter media.

18. The filter of claim 16 wherein said first filter media includes coarse particles and said second filter media includes particles finer than said coarse particles such that said second filter media is more densely packed than said first filter media.

19. The filter of claim 16 wherein said first filter media includes a first porous filter paper and said second filter media includes a second porous filter paper, wherein said second porous filter paper is less porous than said first porous filter paper.

20. The filter of claim 16 wherein said filter media includes at least one additive for treating said engine oil, said at least one additive added to said first filter media, said second filter media, or said first and second filter media.

21. The filter of claim 20 wherein said filter media includes said at least one additive for reducing acidity in said circulating engine oil.

22. The filter of claim 21 wherein reducing acidity in said circulating engine oil includes reducing said engine oil Total Acid Number.

23. The filter of claim 22 wherein reducing acidity in said circulating engine oil includes reducing fuel combustion acids including carboxylic acid, nitric acid, nitrous acid, sulfuric acid, or sulfurous acid.

24. The filter of claim 23 wherein reducing said fuel combustion acids includes reducing fuel combustion acids in combination with alkyl groups.

25. The filter of claim 20 wherein said at least one additive provides base in said filter media.

26. The filter of claim 25 wherein providing base in said filter media includes maintaining a total base number (TBN) of approximately 5.

27. A filter for removing contaminants from circulating fluid, said filter comprising:
a canister housing in flow communication with said circulating fluid, having an inlet, an outlet, a first portion, and a detachable second portion, said first and second portions securably attached to seal said circulating fluid therein;
a first filter media housed in said first portion adjacent said inlet; and
a second filter media housed in said second portion;
wherein said first and second filter media are in fluid communication with said circulating fluid and form a dual-flow circulation path within said canister, including a substantially full-flow path filtered by said first filter media and a reduced-flow path filtered by said second filter media.

28. The filter of claim 27 wherein said first filter media receives substantially all of said circulating fluid to said canister from said inlet, and said second filter media receives a reduced portion of said circulating fluid.

29. The filter of claim 27 wherein said filter media includes at least one additive for treating said circulating fluid, said at least one additive added to said first filter media, said second filter media, or said first and second filter media.

30. The filter of claim 29 wherein said filter media includes said at least one additive to assist in accumulating and removing said contaminants from said circulating fluid.

31. The filter of claim 27 wherein said second portion and said second filter media are removed from said first portion when accumulation of said contaminants in said second filter media exceeds a predetermined amount.

32. A filter for removing contaminants from circulating engine oil in an engine, said filter comprising:
a canister housing in flow communication with said circulating engine oil, having an inlet, an outlet, a first portion attached to said engine, and a detachable second portion, said first and second portions securably attached to seal said circulating engine oil therein;
a first filter media housed in said first portion adjacent said inlet; and
a second filter media housed in said second portion;
wherein said first and second filter media are in fluid communication with said circulating engine oil and form a dual-flow circulation path within said canister, including a substantially full-flow path filtered by said first filter media and a reduced-flow path filtered by said second filter media.

33. The filter of claim 32 wherein reduced volumetric flow of said circulating engine oil in said second filter media is caused by a pressure differential between said first filter media and said second filter media, said pressure differential resulting from said circulating engine oil flowing through said first filter media and said second filter media.

34. The filter of claim 32 wherein said filter media includes at least one additive for treating said circulating engine oil, said at least one additive added to said first filter media, said second filter media, or said first and second filter media.

35. The filter of claim 34 wherein said at least one additive reduces said circulating engine oil Total Acid Number, thereby reducing fuel combustion acids including reducing carboxylic, phenolic, nitric, nitrous, sulfuric, and sulfurous acids.

36. The filter of claim 32 further including a non-porous barrier between said first portion and said second portion, said barrier having an orifice for ingress and egress of circulating engine oil between said first and second portions.

37. The filter of claim 36 wherein said orifice in said non-porous barrier forms a pressure differential between said first portion and said second portion such that volumetric flow of said circulating engine oil to said second portion is restricted.

38. A method for accumulating and removing suspended particles in an engine oil filter, said method comprising:
flowing circulating engine oil into said filter having a high volumetric flow portion and a restricted volumetric flow portion, said filter attached to an engine and in fluid communication with said circulating engine oil, wherein said circulating engine oil flows into and out of said high volumetric flow portion of filter;
forming said restricted volumetric flow portion within said filter, said restricted volumetric flow portion in fluid communication with said high volumetric flow portion of said filter, such that a reduced amount of volumetric flow of said circulating engine oil within said filter flows through said restricted volumetric flow portion;
accumulating said suspended particles when said circulating engine oil traverses through said restricted volumetric flow portion;
removing said suspended particles by removing said restricted volumetric flow portion of said filter.

39. The method of claim 38 further including physically separating said restricted volumetric flow portion from said high volumetric flow portion to remove said suspended particles accumulated in said restricted volumetric flow portion.

40. The method of claim 39 further including replacing said restricted volumetric flow portion with a new restricted volumetric flow portion when a predetermined level of suspended particles has accumulated.

41. The method of claim 39 further including providing additives to said restricted volumetric flow portion for treating said circulating engine oil or accumulating said suspended particles.

42. The method of claim 40 wherein replacing said restricted volumetric flow portion includes replacing a filter media within said restricted volumetric flow portion.

43. The method of claim 38 further including providing a first filter media to said high volumetric flow portion and a second filter media to said restricted volumetric flow portion, wherein said second filter media is less porous than said first filter media.

44. The method of claim 38 wherein forming a restricted volumetric flow portion includes providing a pressure differential between said high volumetric flow portion and said restricted volumetric flow portion, such that said pressure differential limits circulation engine oil flow to said restricted volumetric flow portion.

45. The method of claim 44 wherein providing said pressure differential includes providing a barrier between said high volumetric flow portion and said restricted volumetric flow portion of said filter, said barrier having an orifice for said circulation engine oil ingress and egress at a volumetric flow rate substantially less than said circulating engine oil volumetric flow rate to said high volumetric flow portion of said filter.

46. The method of claim 38 wherein restricted volumetric flow of said circulating engine oil in said second filter media is caused by a pressure differential between said first filter media and said second filter media, said pressure differential resulting from differences in porosity between said first filter media and said second filter media.

47. The method of claim 41 wherein at least one additive provides base to said filter media.

48. The method of claim 38 further comprising replacing at least a portion of said circulating engine oil upon after removal of said restricted volumetric flow portion of said filter.

49. A filter for removing contaminants from circulating fluid, said filter comprising:
a filter canister having an inlet and an outlet;
a first filter media; and
a second filter media;
wherein said first filter media is adjacent said inlet, said first and second filter media within fluid communication with said circulating fluid and forming a dual-flow circulation path within said canister, including a full-flow path filtered through said first filter media and a reduced-flow path filtered through said second filter media.

50. A filter for removing contaminants from circulating fluid, said filter comprising:
a filter canister having an inlet and an outlet;
a filter media; and
a second media;
wherein said filter media is adjacent said inlet, said filter media and said second media within fluid communication with said circulating fluid and forming a dual-flow circulation path within said canister, including a full-flow path filtered through said filter media and a reduced-flow path filtered through said second media.
